(19) United States
(12) Patent Application Publication
(10) Pub. No.: US 2007/0130520 A1
(43) Pub. Date: Jun. 7, 2007

(54) Extensible web service policy behavior

(75) Inventors: Mark W. Skunberg, Fargo, ND (US); Michael V. Lee, Fargo, ND (US); Tristan Cartony, Fargo, ND (US); William F. Pfingsten, Davenport, ND (US); Michael Isley, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/294,014

(22) Filed: Dec. 5, 2005

(51) Int. Cl. G06F 3/00; G06Q 40/00; G06F 9/44

(52) U.S. Cl. 715/700; 705/35; 717/105

(57) ABSTRACT

A system for remotely providing services includes an object model having a behavior option object that is indicative of one of a plurality of different ways in which a service behavior can be performed.

### BACKGROUND

Generally speaking, a web service is a software system that allows a server to expose functionality that clients can utilize. A web service typically incorporates standardized means for enabling one application to invoke a method of another application. The result is interoperable machine-to-machine interaction between computer systems that are in some way connected, such as by a local area network, or, more commonly, by the Internet.

Within a web service environment, it is sometimes desirable for a service to be configured to perform a particular task in several different ways. Current attempts to support such functionality have typically involved decorating a schema (e.g., the schema associated with an applicable message format protocol) with various attributes that mandate certain task responses, or adding parameters to the contract. This generally pollutes and clutters the schema, which is a disadvantage at least in that it can lead to an overall increase in errors. It also requires a change in the schema each tiem a new behavior is discovered, thus breaking the current contract. Further, current systems generally fail to provide a practical way to express what options a service supports. Thus, for at least these reasons, there currently is no effective way to influence how a service satisfies a request.

The discussion above is merely provided for general background information and is not intended for use as an aid in determining the scope of the claimed subject matter. Further, it should also be emphasized that the claimed subject matter is not limited to implementations that solve any or all of the disadvantages of any currently known systems noted in this section or elsewhere in the present description.

### SUMMARY

A system for remotely providing services includes an object model having a behavior option object that is indicative of one of a plurality of different ways in which a service behavior can be performed. This Summary is provided to introduce concepts in a simplified form that are further described below in the Detailed Description. This Summary is not intended to identify key features or essential features of the claimed subject matter, nor is it intended for use as an aid in determining the scope of the claimed subject matter.

### BRIEF DESCRIPTION OF THE DRAWINGS

FIG. 1 is a block diagram of one computing environment in which some embodiments may be practiced.

FIG. 2 is a schematic diagram of a web service system.

FIG. 3 is a flow chart diagram illustrating steps associated with manipulating service behavior options.

FIG. 4 is a diagrammatic illustration of an object model.

FIG. 5 is a diagrammatic view of a data model.

FIG. 6 is a schematic diagram demonstrating that, when a developer or service consumer configures a desired behavior scheme or arrangement, some objects might be new while other objects are pre-existing.

### DETAILED DESCRIPTION

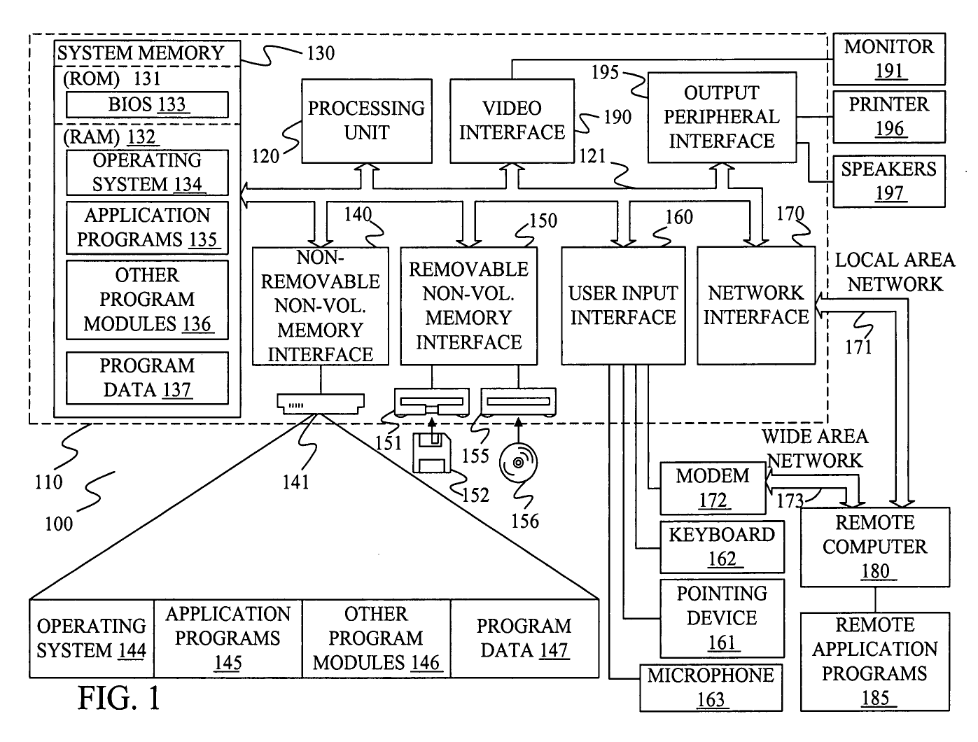

FIG. 1 illustrates an example of a suitable computing system environment 100 in which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

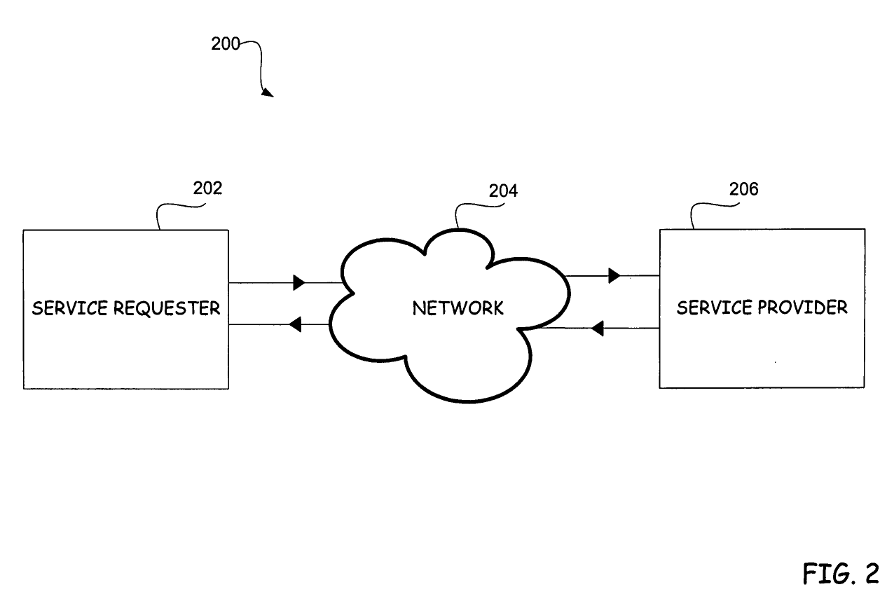

FIG. 2 is a schematic diagram of a web service system 200. It should be noted that the scope of the present invention is not limited to a web service environment. Embodiments could just as easily be applied within other environment, including any type of service environment.

System 200 includes a service requester 202 that is configured for communication with a service provider 206. The communication is conducted over a network 204. Provider 206 (e.g., a computing device configured to operate as a server) is configured to expose functionality that is utilized by requester 202 (e.g., a computing device configured to operate as a client). Those skilled in the art will appreciate that, in many cases, system 200 will be configured such that a client application affiliated with service requester 202 is able to invoke a service tied to an application affiliated with service provider 206.

The medium 204 over which requester 202 and provider 206 communicate is a computer network, such as a LAN or the Internet. Messages between the systems are illustratively, all though not necessarily, transported in accordance with the Hypertext Transfer Protocol (HTTP). Other transport protocols could be implemented such as, but not limited to, the Simple Mail Transfer Protocol (SMTP).

Provider 206 exposes functionality as a set of methods that, when called by requester 202, perform some action and/or return some data. The methods exposed by provider 206 can illustratively accept an arbitrary number of input parameters, and can optionally return a result. Certain standards may apply for administrative purposes such as to handle faults and/or dictate how input parameters and return values are exchanged.

In many cases, a particular message format protocol will be implemented in order to facilitate effective communication between requester 202 and service provider 206. One example of such a protocol is the Simple Object Access Protocol (SOAP), which is an XML-encoded messaging protocol that is commonly used to marshal input parameters and return values associated with a web service method. This is but one example of an appropriate protocol for message formats.

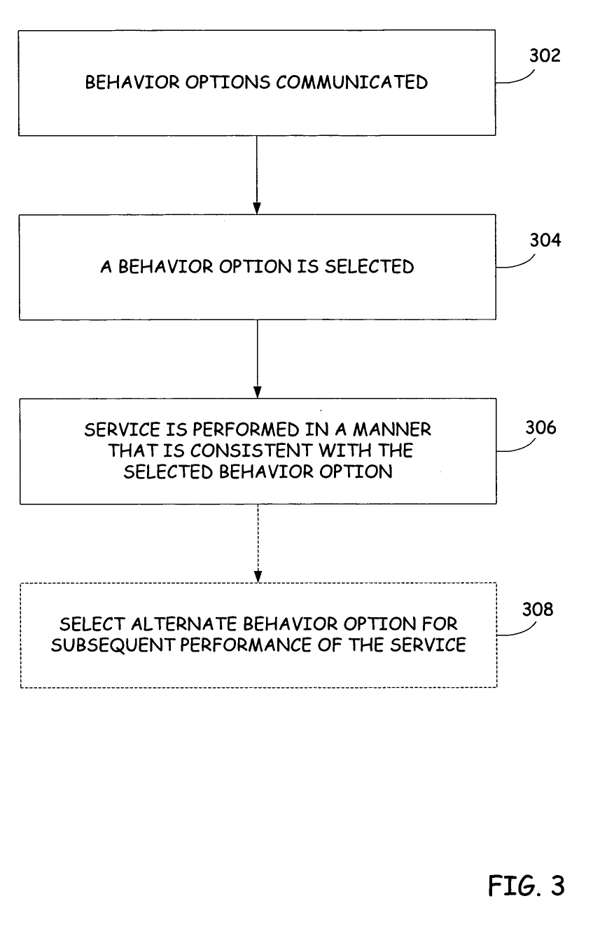

It is sometimes desirable for provider 206 to be configured to enable execution of a particular service behavior in several different ways. FIG. 3 is a flow chart diagram illustrating steps associated with manipulating service behavior options. In accordance with block 302, service behavior options are communicated (e.g., mode known to a web service consumer). In accordance with block 304, a behavior option is selected (e.g., by a service request consumer, by a system administrator, automatically based on contextual characteristics, etc.). Finally, in accordance with block 306, a service is performed in a particular way based on the selected behavior option. In accordance with an optional step 308, a different behavior option can be selected and applied to subsequent performance or execution of the service behavior.

As an example of how the method of FIG. 3 can be applied, one can imagine a scenario wherein a particular web service supports the creation of a new customer record. When a customer is added from a web service, it may be important to ensure that the new customer is a good quality customer. An owner (or manager, etc.) may want to check the new customer's credentials (e.g., credit score, etc.) before a formal business relationship is established. Under these circumstances, it may be desirable to enable the owner (or manager, etc.) to configure a general customer policy in order to affect the process of how a new customer is created. For example, it may be desirable to configure the system such that new customers created by the web service are created in an “inactive” state. That being said, it may also be desirable to allow the owner (or manager, etc.) to choose between the “active” state, or a “default” state, or some other option to be applied to the creation of new customers.

Generally speaking, the example scenario involves configuring a system to support creation of a new customer in accordance with a variety of different behavior options. One way to implement such a functionality is to configure a system to enable an owner (or manager, etc.) to manipulate a customer policy such that a service behavior can be set to one of a plurality of options that are functionally bound to the web service. For example, a customer policy scheme or arrangement can be generally implemented as follows:

| | |
|---|---|
| Policy: | Customer |
| Behavior: | Create Customer Behavior |
| Behavior Option: | Use Active Option |
| Behavior Option: | Use Inactive Option |
| Behavior Option: | Use Default Option |

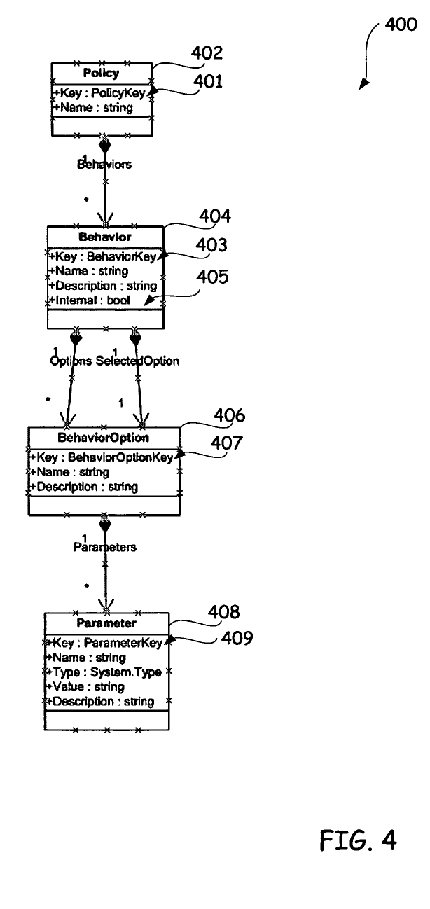

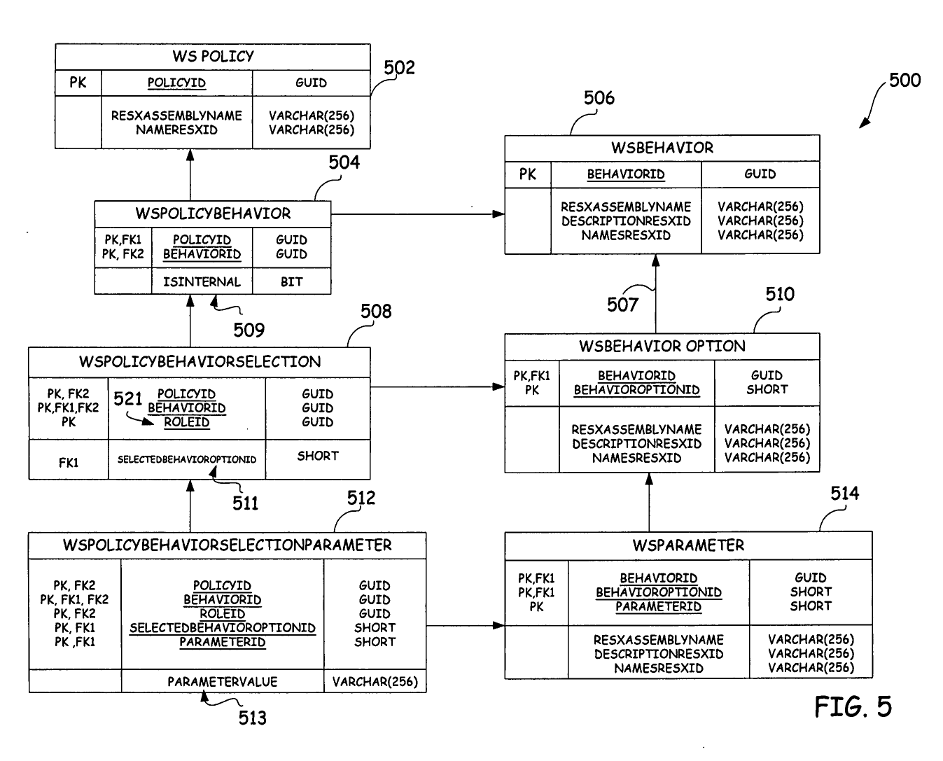

Policy schemes or arrangements such as this one can be implemented as part of an extensible framework that empowers a web service developer to support the creation, communication, selection and execution of service behavior alternatives. An example of such a framework is described below in relation to FIGS. 4 and 5.

It is worth noting that similar schemas or arrangements are also within the scope of the present invention. For example, policies might be operation specific. Thus, rather than having a customer policy, there might be a create customer policy, an update customer policy, a delete customer policy, etc. Corresponding adjustments would assumedly be made to the other parts of the arrangement (i.e., to the behaviors, options, etc.). This is but one example of a variation that can be made without departing the scope of the present invention.

Another example scenario involves a sales order web service. When a new order is submitted in the context of such a service, a check is illustratively performed to determine whether there is a sufficient quantity of inventory to allocate to the order. Behavior options can be implemented as a mechanism for dealing with a detected shortage in inventory. For example, depending on a selected behavior option, the order could be canceled, the shortage may be overridden, the order may be back ordered, or the balance may be back ordered. The overall policy scheme or arrangement can be implemented as follows:

| | |
|---|---|
| Policy: | Sales Order |
| Behavior: | Quantity Shortage Behavior |
| Behavior Option: | Cancel Order |
| Behavior Option: | Override Shortage |
| Behavior Option: | Back Order |
| Behavior Option: | Back Order Balance |

In one embodiment, the web service framework can be leveraged so as to enable different service behavior options to be active in different contexts. It may be desirable for certain service behavior options to be applied on a role-specific or user-specific basis. For example, assuming the system is configured to do so, a given salesperson may choose to set all inventory shortages associated with their own sales to be overridden (e.g., because they want their orders to succeed). A different, more cautious salesperson may choose to make the decision on a per order basis (e.g., because each customer has different needs and they do not want to frustrate their customers).

In one embodiment, rules pertaining to service behavior options can be made on a higher level so as to limit options available to certain users or those with certain roles. For example, assuming the system is configured to do so, a system administrator (e.g., an owner or manager) may choose to reserve “override shortage” as an option available only to management and not to salespeople. In this case, the “override shortage” option will illustratively be presented to authorized users as a selectable behavior option (i.e., management) but will not be so presented to unauthorized users (i.e., salespeople). In one embodiment, a system administrator similarly tailors access to behavior options based on the identity of an individual user rather than the individual's role (e.g., the “override shortage” option is made unavailable to salesperson Fred Parker).

In one embodiment, the web service framework can be leveraged so as to enable automatic selection of service behaviors under predetermined circumstances. For example, a system administrator can illustratively configure the system to automatically default to “Back Order” for inventory shortages when a sales order is received from an unknown customer across the Internet. Assumedly, the system would also be configured to allow the administrator to override the default, to choose a new default option, or to open up more options in order to support a behavior option selection process.

The example scenarios discussed up to this point have generally pertained to how behavior options are utilized once implemented. This has assumed implementation of a development framework utilized by a web service developer to support the described policy schemas through the creation, communication, selection and execution of service behavior alternatives. In one embodiment, the general concept of behavior option alternatives is implemented as a consistent feature of a web service development framework. This feature enables a developer to customize a policy by taking and describing any behavior, a set of associated behavior options, and possibly restrictions to be placed upon availability and/or applicability of one or more of the defined options. In one embodiment, a development tool (e.g., user interface components, a wizard, etc.) is provided to assist in the creation and definition of service behavior alternatives.

FIG. 4 is a diagrammatic illustration of an object model 400. Object model 400 provides a system for describing service behaviors within a web service framework that supports service behavior alternatives. Object model 400 is generally consistent with the service schemes or arrangements described above in the context of the example scenarios.

At the top of the object model framework is a policy object 402 (e.g., customer). A web service developer can illustratively implement a plurality of web service policy objects. The contents of a policy object may include, but are not limited to, the illustrated key and string used to describe the policy and/or policy object.

Beneath the policy object is one or more behavior objects 404 (e.g., create customer). A web service developer can illustratively implement one or more behavior objects that are associated with a corresponding policy. Similar to the contents of a policy object, the contents of a behavior object may include, but are not limited to, the illustrated key and string for descriptive purposes. The behavior object also illustratively includes a string that provides descriptive characteristics of a behavior associated with the behavior object.

It should be emphasized that object model 400 supports the concept that components associated with the described objects become uniquely identifiable (e.g., based on object keys 401, 403, 407, 409, etc. that identify corresponding objects). In other words, the object model enables specific behaviors, behavior options, policies and parameters (which will be discussed below) to be uniquely identifiable based on their corresponding object identifiers. This is advantageous at least in that it enables objects to be re-used rather than re-created.

As is indicated by arrow 405, a behavior object 404 can also include an indication of whether a particular behavior is internal or external. The designation of internal or external generally identifies whether or not the behavior is to be exposed to consumers outside of the internal functional environment of the web service. For example, applications are typically built on top of web services, and those applications generally are configured to control and access a given set of behaviors. However, they do not necessarily get access to all existing behaviors. The ones that are accessible are those that are designated external. The ones that are designated internal are the ones that the sponsor (e.g., owner, system administrator, etc.) of the web service gets to configure for subsequent application to every request going to the web service.

Beneath a behavior object is zero or more behavior option objects 406 (e.g., use active option, use inactive option, use default option). A web service developer can illustratively implement one or more behavior options that are associated with a corresponding behavior. Similar to the contents of the policy and behavior objects, the contents of a behavior option object may include, but are not limited to, the illustrated key and string for descriptive purposes. The behavior option object also illustratively includes a string that provides descriptive characteristics of a behavior option. As is illustrated, one of the behavior option objects is designated as being a selected option.

Beneath a behavior option object is one or more parameter objects 408. In one embodiment, some behavior options will not make sense, or will not be executable, without reliance on an element of retrieved data. The element of retrieved data is provided through the concept of a parameter. Generally speaking, a parameter provides extra information that is needed in order to support a behavior option. For example, suppose the framework was implemented based on a sales order policy schema formulated as follows:

| | |
|---|---|
| Policy: | Sales Order |
| Behavior: | ID Inventory Warehouse |
| Behavior Option: | Default To Parameter |
| Behavior Option: | Support Manual Input |
| Behavior Option: | Retrieve Default |

In this example scenario, part of the sales order policy schema illustratively includes identifying a warehouse from which inventory being sold will be shipped. Some consumers of the web service may not be familiar with the system for identifying warehouses. Thus, the behavior options are implemented in order to facilitate the process of selecting an appropriate warehouse identifier. One option is to allow the user to support input of the identifier manually. Another option is for the identifier to be a default value retrieved from an existing source (e.g., an appropriate warehouse identifier is looked up in a chart based on the type of inventory being sold). A third option, however, is for an administrator to set up a default warehouse (e.g., system will default to a particular value thereby eliminating the need for the web service consumer to provide a value). This default value is illustratively supplied through implementation of a parameter object 408. The system could be set up to allow salespeople to choose an identifier (e.g., they assumedly are familiar with the warehouse identification scheme or arrangement), while at the same time defaulting for other users (e.g., outside purchasers interaction over the Internet).

A web service developer can illustratively implement one or more parameters that are associated with a corresponding behavior option. Similar to the contents of the other objects, the contents of a parameter object may include, but are not limited to, the illustrated key and string for descriptive purposes. The parameter object also illustratively includes a string that provides descriptive characteristics of a parameter. As is illustrated, the parameter object also include value information, assumedly this is the information to be incorporated by the associated behavior option. In one embodiment, a parameter could be a serialized object (e.g., a customer object containing diverse customer information, a warehouse object containing warehouse information, etc.). In one embodiment, the parameter may include an indication of the parameter data type (e.g., string, date, integer, a serialized object, etc.).

Object model 400 provides an organized scheme or arrangement for describing service behaviors (e.g., policy, behavior, behavior option and parameter). Unique instances, defined by key values, can be used to express service policy, external behaviors, internal behaviors, behavior options and parameters. By binding a service to a unique policy key, a service policy can be extended by just adding more behaviors, behavior options and/or parameters to the data source.

FIG. 5 is a diagrammatic view of a data model 500. Data model 500 is illustratively configured to operate in coordination with the object model 400 illustrated in FIG. 4.

Within data model 500, the concept of a behavior is implemented as a behavior table 506. As is illustrated, behavior table 506 includes a “behaviorID,’ which is illustratively a primary key linked to the behavior table. The concept of a behavior option is implemented as a behavior option table 510. Behavior option table 510 is a child table of behavior table 506 (indicated by arrow 507). Thus, the primary key to behavior table 510 is the behaviorID key as it appears in the behavior table above it, plus a behaviorOptionID key. Accordingly, the primary key for behavior option table 510 is made up of two pieces. The foreign key is the behaviorID key pointing back to behavior table 506. This parent-child organization scheme or arrangement similarly applies throughout data model 500. Thus, the different components are identifiable based on unique key values.

Starting from the top of data model 500, the concept of a policy is implemented as a policy table 502. As has been alluded to, a policy (e.g., customer, sales order, etc.) is a top component of the schema described herein. A policy behavior table 504 is related to policy table 502. Policy behavior table 504 is illustratively a link table that links policy table 502 to a behavior (e.g., through a relationship with one or more behavior tables 506). For example, if there were fifty behaviors and five policies, then the assumption is that the behaviors for any given policy could be mixed and matched. Thus, a given behavior need be entered in only once, and then it can be re-used against different policies. The policy behavior table 504 facilitates the linking to one or more policy tables 506. As is indicated by arrow 509, table 504 can also be where a bit is included to serve as an indication of internal or external applicability.

A policy behavior selection table 508 is related to policy behavior table 504. In one embodiment, table 508 is related to the process of selecting an available behavior option (e.g., in association with one or more behavior option tables 510). As is indicated by arrow 511, an explicit indication of a selected option(s) may be included. In one embodiment, table 508 is also where the concepts of roles and security rights come into play. Table 508 is illustratively configured to reflect the concept that certain roles or user identities can be assigned access to certain behavior options. Different configurations can be implemented depending on a desired security policy.

A policy behavior selection parameter 512 is illustrated as being related to policy behavior selection table 508 and parameter table 514. Arrow 513 points to an example instance of a parameter value. Parameter table 514 is shown as being related to behavior option table 510. The function of a parameter was discussed in relation to the object model. In general, both parameter tables 512 and 514 are configured to supply data as necessary to support the behavior selection functionality associated with tables 508 and 510.

In one embodiment, behavior selection (e.g., as implemented through policy behavior selection table 508) is configured on a role-specific or user-specific basis. A default configuration is illustratively defined for a given role, such that only role variations need be configured. Any number of roles can illustratively be added and configured. Information may be stored as necessary in table 512 to support role-based determinations (although table 512 may serve a different or additional function as well).

In one embodiment, table 508 illustratively includes default selections that are automatically applied based on assumption (e.g., default role-to-access assumptions, default security options, default behavior option selections, etc.) such that only policies (e.g., role-to-access assignments) that need to be customized need be added. Thus, in one embodiment, a main purpose for table 508 is to identify applicable default selected behavior options.

Thus, FIG. 4 provides an object model and FIG. 5 provides an applicable data model. Those skilled in the art will appreciate that simple variations in implementation can be made without departing from the scope of the present invention. Those skilled in the art will also appreciate that the present invention contemplates the generation of computer code that leverages the object model and the associated data model.

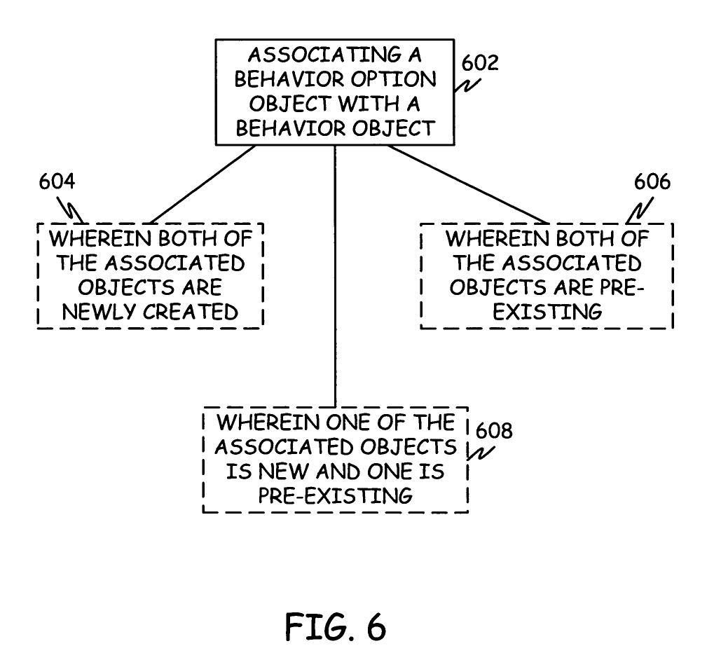

FIG. 6 is a schematic diagram demonstrating that, when a developer or service consumer configures a desired behavior scheme or arrangement, some objects might be new while other object are pre-existing. Block 602 shows a method step wherein a behavior option object is associated with a behavior object. This block could be filled in with any object-to-object association within the described object data model (e.g., an association between a parameter object and a behavior option object, between a behavior object and a policy object, etc.). As is indicated by block 604, both objects might be newly created. As is indicated by block 606, both object might be pre-existing (e.g., existing objects are identified and recycled). As is indicated by block 608, one of the objects might be new while the other one is pre-existing. FIG. 6 emphasizes the convenient extensibility of the proposed system.

In one embodiment, the object and data models are leveraged such that after a consumer has requested the policy for a given service, he/she/it can select which behaviors they are interested in influencing and then review related behavior choices and options. The consumer influences the service by sending policy back to the service with selected behavior options. Before a service processes a request, the consumers' policy is applied to service default policy to ensure that all external and internal behaviors are applied in combination with selected options. Through the received policy and its unique keys, the service is equipped with some understanding as to how the consumer and the owner want the service to behave.

The described object-data model is extensible in that it can be applied to any web service operation. The model can be utilized to describe what behaviors exist for a web service operation, the behavior options for each behavior and any applicable parameters. A selected option for each configurable behavior influences how the web service behaves in the applicable context. Behaviors are illustratively re-usable across web service operations.

Further, the model enables a web service operation to be extended by initial creators and then customized by other parties. The model even supports the addition of additional behaviors, behavior options and parameters as desired after initial creation. In one embodiment, each legal company within an organization can configure policy as they wish. In another embodiment, each role within an organization can be configured as desired. In one embodiment, an ISV or an application developer is able to leverage the described framework in order to create an entirely new Policy for their own use.

Still further, behaviors can be described as internal (e.g., owner of the web service operation) or external (e.g., consumer of the web service operation). External behaviors can potentially be changed (e.g., by the consumer) on every request to the service. External behaviors can be switched to internal, and internal behaviors can be switched to external.

It is contemplated that people may need to understand behavior implementation in different cultures, in particular within different languages. Thus, in one embodiment, pointers are plugged into the data model back to the object model indicating where a text description is for a particular name or description (e.g., of a behavior or behavior options). In this regard, data model 500 demonstrates that there is a capture of a resource identifier and an assembly name for text that describes a given policy, behavior, behavior option and/or parameters. This is advantageous at least in that when a particular instance is materialized, the culture of the consumer can be utilized as a basis for looking up an appropriate name and description. Because the assembly and resource identifiers are tracked, a given policy can be easily extended when desired or necessary. It is worth noting that, within FIG. 5, references to resources identified as “ResX” are generally pointers to a ResX assembly, which enables strings to be altered based on a particular applicable culture or language. Thus, resource names and descriptions are localizable.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented system for remotely providing services, the system comprising an object model that includes a behavior option object that is indicative of one of a plurality of different ways in which a service behavior can be performed.

2. The system of claim 1, wherein the behavior option object is assigned an identifier that distinguishes it from other behavior option objects.

3. The system of claim 2, wherein the behavior option object is assigned an identifier that distinguishes it from another behavior option object that is indicative of another way in which the service behavior can be performed.

4. The system of claim 1, wherein the object model further comprises a behavior object associated with the behavior option object.

5. The system of claim 4, wherein the object model further comprises a policy object associated with the behavior object.

6. The system of claim 1, wherein the object model further comprises a parameter object associated with the behavior option object.

7. The system of claim 1, further comprising a database system that includes a behavior option database table that is related to the behavior option object.

8. The system of claim 1, further comprising a database system that includes a policy behavior selection database table configured to facilitate an identification of the behavior option object as a selected behavior option object.

9. The system of claim 1, wherein the object model further comprises an object entry designating whether the behavior option object is to be communicated internally or externally.

10. The system of claim 1, further comprising a database system that includes at least one database table configured to support an assignment of access rights based on a characteristic of one or more users.

11. The system of claim 10, wherein said at least one database table is configured to support an assignment of access rights based on a designated user role.

12. A computer-implemented method for configuring how a service provider performs a service, the method comprising:
providing an indication of a plurality of behavior options associated with a service behavior;
receiving a selection input that is indicative of one of the behavior options for zero or more of the service behaviors;
performing the service behavior in a manner that is consistent with a behavior option that corresponds to the selection input.

13. The method of claim 12, wherein providing an indication of a plurality of behavior options associated with a service behavior further comprises providing an indication of a plurality of behavior options in a manner that is consistent with a designation related to internal or external applicability.

14. The method of claim 12, wherein providing an indication of a plurality of behavior options associated with a service behavior further comprises providing an indication of a plurality of behavior options in a manner that is consistent with a designation related to a characteristic of one or more users.

15. The method of claim 12, wherein providing an indication of a plurality of behavior options associated with a service behavior further comprises providing an indication of a plurality of behavior options in a manner that is consistent with a designation related to zero or more user roles.

16. The method of claim 12, further comprising receiving a different selection input that is indicative of a different behavior option to be applied to subsequent execution of the service behavior.

17. A computer-implemented method for configuring how a service provider provides a service, the method comprising associating a behavior object with a policy object.

18. The method of claim 17, further comprising associating a behavior option object with the behavior object.

19. The method of claim 18, wherein associating a behavior object further comprises associating a newly created behavior option object with a pre-existing behavior object.

20. The method of claim 18, wherein associating a behavior object further comprises associating a newly created behavior option object with a newly created behavior object.
